(19) United States
(12) Patent Application Publication
(10) Pub. No.: US 2026/0163506 A1
(43) Pub. Date: Jun. 11, 2026

(54) TWO-TRIGGER CONTROL FOR OUTDOOR POWER TOOLS

(71) Applicant: Milwaukee Electric Tool Corporation, Brookfield, WI (US)

(72) Inventors: Rade S. Latinovich, Brookfield, WI (US); Faraz Mohsinuddin, Tomball, TX (US); Fabian P. Landeta, Waukesha, WI (US)

(21) Appl. No.: 19/368,891

(22) Filed: Oct. 24, 2025

Related U.S. Application Data
(60) Provisional application No. 63/713,354, filed on Oct. 29, 2024.

(51) Int. Cl. H02P 7/22; B62D 51/00; B62D 51/04; G05G 1/01

(52) U.S. Cl. CPC H02P 7/22; B62D 51/002; B62D 51/04; G05G 1/01

(57) ABSTRACT

An outdoor power tool and a method of operating the outdoor power tool are provided. The outdoor power tool includes a tool assembly, a drive assembly, a handle assembly, a control system comprising a control circuit, a first trigger and a second trigger. The first trigger and the second trigger are each electrically connected to the control circuit. The control system is configured to initiate supply of electric power to the drive assembly when an input is received at the control circuit from both the first trigger and the second trigger.

### CROSS-REFERENCE TO RELATED APPLICATIONS

The present application claims priority to U.S. Provisional Patent Application Ser. No. 63/713,354 filed on Oct. 29, 2024, the disclosure of which is incorporated by reference herein in its entirety.

### FIELD

The present disclosure relates generally to controls for walk behind power tools, and more particularly, controls having two triggers for walk behind power tools.

### BACKGROUND

Walk behind outdoor power tools are generally utilized in landscaping operations. To assist the user with pushing the walk behind tool, a drive assembly is often present including a motor to provide a powered drive to wheels of the walk behind tool. As a safety mechanism, most, if not all, walk behind outdoor power tools include a multi-step action for driving the wheels.

A typical walk behind outdoor power tool arrangement for multi-step action for driving the wheels may include a bail bar at the handle. The bail bar may be configured to allow for selective actuation of the motor and is typically required to be engaged for the motor to be actuated. If the bail bar is not engaged, the motor cannot start; and if the bail bar is released, the motor stops. However, the requirement for a user to engage and hold the bail bar for the entire duration of operating the walk behind tool can be burdensome. For instance, it may be uncomfortable and even fatiguing to the user's hands for a user to squeeze the bail bar and handle together for the duration of operation of the tool. To effectively maintain operation of walk behind power tools, squeezing the bail bar with both hands may be necessary.

Accordingly, improved control systems for outdoor power tools are desired in the art. In particular, multi-action control systems for outdoor power tools which do not require continuous action using two hands would be advantageous.

### BRIEF DESCRIPTION

Aspects and advantages of the present disclosure will be set forth in part in the following description, or may be obvious from the description, or may be learned through practice of the technology.

In accordance with one embodiment, an outdoor power tool is provided. The outdoor power tool includes a tool assembly, a drive assembly, a handle assembly, a control system comprising a control circuit, a first trigger and a second trigger. The first trigger and the second trigger are each electrically connected to the control circuit. The control system is configured to initiate supply of electric power to the drive assembly when an input is received at the control circuit from both the first trigger and the second trigger.

In accordance with another embodiment, a method of operating a power tool is provided. The outdoor power tool includes a drive assembly, a control system, and a first trigger and a second trigger. The method includes steps of: pressing the first trigger and the second trigger simultaneously; the control system causing initiation of the drive assembly as a result of the step of pressing the first trigger and the second trigger simultaneously; operating the drive assembly with the first trigger and/or the second trigger pressed; and ceasing operation of the drive assembly when neither the first trigger nor the second trigger is pressed These and other features, aspects and advantages of the present disclosure will become better understood with reference to the following description and appended claims.

The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a front view of a walk behind power tool in accordance with embodiments of the present disclosure;

FIG. 2 is a schematic diagram of the controller for a power tool in accordance with embodiments of the present disclosure;

FIG. 3 is an exemplary method of operating a power tool in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

As used herein, the term “operably connected” refers to a mechanical and/or electrical connection between two or more elements, whether they are directly connected to one another, or are connected via one or more intermediate components, such that the mechanical or electrical output of one element is passed directly or indirectly to the operably connected second component.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, outdoor power tools, such as walk behind outdoor power tools, can be used to conduct a variety of landscaping operations. For instance, as disclosed herein, outdoor power tools can include motors to provide supplemental power to the wheels and/or the tool unit. The power tool of the present disclosure includes a first trigger and a second trigger. Both the first trigger and the second trigger may require being pressed in order to start the power tool. After starting the power tool, only one trigger is required to be pressed to continue operating the power tool. The triggers may be variable speed triggers, and a controller of the power tool may use an input from whichever trigger is pressed a greatest amount in order to control the speed of the power tool.

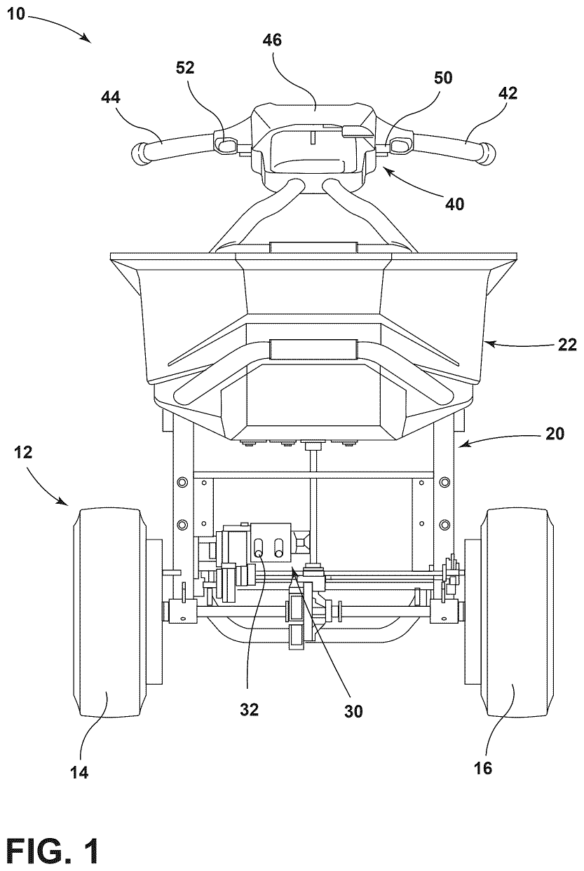

Referring now to the drawings, FIG. 1 illustrates a walk-behind outdoor power tool 10. While the power tool 10 illustrated in FIG. 1 is a spreader that can be used to spread (e.g., distribute) material stored in a hopper across a surface (e.g., grass, garden, or the like) as the spreader is traversed over the ground, the present invention further contemplates that the power tool 10 may comprise a lawn mower, a snow thrower or snowblower, a walk-behind fan, an edger, a tiller, a dethatcher, an aerator, a cultivator, or other power tool.

The power tool 10 generally includes a traversing element 12 for traversing the power tool 10 over an area. For instance, as illustrated in FIG. 1, the traversing element 12 can comprise one or more wheels such as a first wheel 14 and a second wheel 16. A power tool 10 having only two wheels and no operator seat (such as illustrated in FIG. 1) can also be referred to as a walk-behind power tool. However, while the traversing element 12 is illustrated as the first wheel 14 and the second wheel 16, it should be appreciated that alternatives may also be realized, such as one or more tracks, rollers, or the like.

The power tool 10 further generally includes a frame 20 and a handle assembly 40 connected to the frame 20. The handle assembly 40 can be disposed upward and rearward from the traversing element 12. The frame 20 can be formed from tubes, plates, and the like. The elements of the frame 20 can be coupled together through weld, fasteners (e.g., threaded fasteners), or the like.

A tool assembly 22 is disposed on the frame 20. In FIG. 1 in which the power tool 10 is a spreader, the tool assembly 22 includes a hopper assembly which defines a receiving area which receives a material to be broadcast by the spreader. The hopper assembly includes one or more dispersion outlets for releasing the material from the receiving area. As disclosed herein, the hopper assembly can include a variety of mechanisms and configurations for controlling the release of the material from the receiving area via the one more dispersion outlets. However, it is to be understood that the tool assembly 22 may include one or more additional and/or alternative tool units operably connected to the frame, e.g., a blade assembly when the power tool 10 is a mower, a snow thrower assembly when the power tool 10 is a snow thrower, etc.

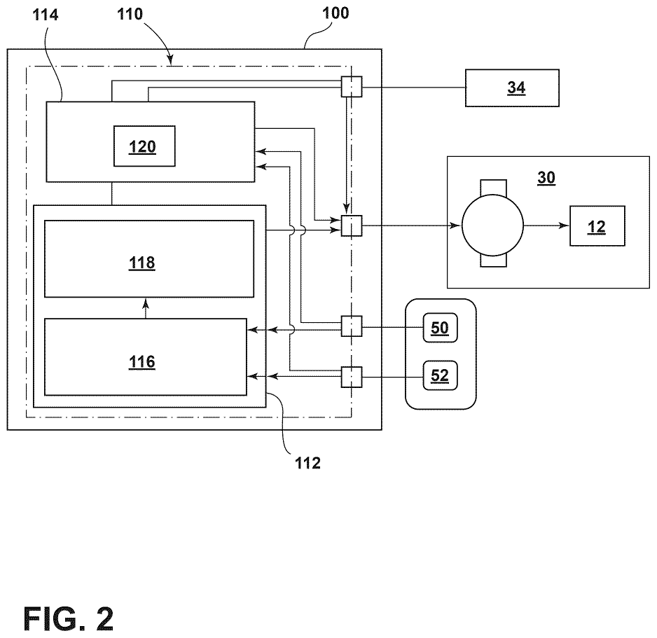

The power tool 10 can further generally include a drive assembly 30 which propels the traversing element 12 and potentially the tool assembly 22. By way of non-limiting example, the drive assembly 30 can include a motor 32 (such as an electric motor as illustrated), an engine, or the like. For embodiments where the drive assembly comprises the electric motor, the power tool 10 can further include one or more batteries 34 (FIG. 2) which provide electrical power to the electric motor. In a particular embodiment, the one or more batteries can include a single battery. In another embodiment, the one or more batteries can include a plurality of batteries. The battery or batteries may be removable, permanently installed, or a combination thereof. The batteries may also be usable on different components other than the power tool 10, such that they can be swappable between different types of tools. The electric motor can include, for example, a brushless DC motor. In some embodiments, the power tool 10 can move at a speed in a range of 0 miles per hour (MPH) and 4 MPH. In certain instances, this movement can occur in only a single direction, e.g., forward. In other embodiments, the movement can occur in two directions, e.g., forward or backwards. The power tool 10 may also be able to traverse ground (i.e., the traversing element 12 can move) even when the electric motor 32 or other drive assembly is not powering said movement. This can enable both manual and powered operation of the power tool, such that it is still functional even if the power source (e.g., battery) runs out or is removed.

As illustrated in FIG. 1, in some embodiments, the handle assembly 40 can comprise a plurality of handles such as a left handle 42 and a right handle 44. The left handle 42 and the right handle 44 may extend on opposite lateral sides with respect to a direction of movement of the traversing element 12. In some arrangements, the handle assembly 40 may include a central portion 46 between the left handle 42 and right handle 44. For instance, the left handle 42 and right handle 44 may extend from the central portion 46. The handle assembly 40 may further comprise one or more operational actuators such as a first trigger 50, a second trigger 52, additional controls (not pictured), and even a user interface (not pictured). As will be disclosed herein, these respective components can operate in coordination with one another, independent of one another, or combinations thereof. The first trigger 50 and the second trigger 52 may each be a variable speed trigger.

As disclosed herein the overall power tool 10 (e.g., FIG. 1) may further include a controller 100 (see, e.g., schematic drawing FIG. 2) configured to control one or more operational parameters of the power tool 10. The controller 100 may be located in the handle assembly 40 (e.g., within the central portion 46) or in any other location suitable for receiving information, processing results, and outputting control mechanisms. The operational parameters can include, for example, the power state of the power tool, the speed of the power tool, or other operational characteristics of the power tool. The controller 100 may be configured to receive input signals from the user interface, controls, first trigger 50 and second trigger 52.

As shown in FIG. 2, the controller 100 includes a control circuit 110. The first trigger 50 and the second trigger 52 are electrically coupled to the control circuit 110. The drive assembly 30, including the motor 32 which is coupled to the traversing element 12, are further electrically coupled to the control circuit 110. The battery 34 is further coupled to the control circuit 110.

The control circuit 110 may include a power module 112 and a speed module 114. The power module 112 may be configured to control whether electric power is supplied to the drive assembly 30, i.e., to operate the power tool 10. More specifically, as shown in FIG. 2, the power module 112 may be configured to control whether electric power is discharged from the battery 34 to supply power to the drive assembly 30. The speed module 114 may be configured to control the speed (velocity) at which the drive assembly 30 is operated.

Both the power module 112 and the speed module 114 may each receive input signals from the first trigger 50 and the second trigger 52. As noted above, the first trigger 50 and the second trigger 52 may each be a variable speed trigger. In particular, the first trigger 50 and the second trigger 52 may each be a variable speed plunge type trigger.

The power module 112 will now be described in further detail. In order to cause electric power to be supplied to the drive assembly 30, the power module 112 must receive an input signal from both the first trigger 50 and the second trigger 52. The first trigger 50 may generate a first trigger input when the first trigger 50 is pressed, and the second trigger 52 may generate a second trigger input when the second trigger 52 is pressed. For instance, the power module 112 may require receiving simultaneous input signals from both the first trigger 50 and the second trigger 52. Stated differently, when a user presses both the first trigger 50 and the second trigger 52 simultaneously, the power module 112 may send a signal enabling power to be supplied to the drive assembly 30 to operate the power tool 10.

In some aspects of the present invention, the power module 112 may include an initiation circuit 116 configured to receive the input signals from the first trigger 50 and the second trigger 52. The initiation circuit 116 may utilize a plurality of field effect transistors (FETs) to act as an “and” gate within the power module 112. The “and” gate of the initiation circuit 116 may require input signals from both the first trigger 50 and the second trigger 52 to enable output of a signal from the power module 112 to initiate supply of power to the drive assembly 30.

After initiation of the power supply to the drive assembly 30, the power module 112 may be capable of maintaining supply of electric power to the drive assembly 30 with one and/or both of the first trigger 50 and the second trigger 52 pressed. In this manner, after the power tool 10 is running, a user has the ability to use either one or both of the triggers 50, 52 to keep the tool 10 running. When both the first trigger 50 and second trigger 52 are released, the power module 112 will send a signal to cease supply of electric power to the drive assembly 30, thereby disabling operation of the tool 10. Stated differently, as long as an input from one or both of the triggers 50, 52 is maintained continuously, the power tool 10 will continue running and the power supply to the drive assembly 30 will be maintained.

For instance, the user may release the first trigger 50 and the power tool 10 will continue operating. Then, the user may press the first trigger 50 again such that both triggers are pressed, then release the second trigger 52 and the power tool 10 will continue operating. Then, the first trigger 50 may be released, and the power module 112 will send a signal to stop supplying power to the drive assembly 30.

In some aspects of the present invention, the power module 112 may include an operation circuit 118 configured to enable the supply of power to the drive assembly 30 with at least one trigger pressed once the power tool 10 is running. For instance, the operation circuit 118 may receive an input signal from the initiation circuit, e.g., the initiation signal. The operation circuit 118 may include a flip flop, where the initiation signal is a flip flop input and the flip flop output is an operation signal. The flip flop output may go high when both triggers 50, 52 are pressed, and stay high when either the first trigger 50 or second trigger 52 is pressed. When both the first trigger 50 and second trigger 52 are released, the flip flop output may go low. When the flip flop output goes low, the output operation signal ceases, thereby stopping the supply of power to the drive assembly 30 and stopping the operation of the power tool 10.

The speed module 114 will now be described in further detail. As described above, both the first trigger 50 and the second trigger 52 are each a variable speed trigger. In other words, each of the triggers 50, 52 may send a signal to the controller 100 to control the speed of the drive assembly 30, i.e., the velocity of the traversing element 12, based on the amount that the trigger is pressed. The speed module 114 may control the speed of the drive assembly 30 based on the trigger that is pressed the most. Stated differently, when both the first trigger 50 and the second trigger 52 are pressed, the speed module 114 controls the speed of the drive unit 30 based on whichever trigger is pressed the most.

In some aspects of the present invention, the speed module 114 may include a trigger comparison circuit 120. The trigger comparison circuit 120 may receive an input from each of the first trigger 50 and the second trigger 52. Each respective input from the first trigger 50 and the second trigger 52 may be operably connected to an operational amplifier (op-amp) which is operably connected to a diode. The operational amplifiers are used together with the diodes to act as an “analog maximum” function. Stated differently, the operational amplifiers may be implemented to determine which input is higher, i.e., maximum, of the first trigger 50 and the second trigger 52. Whichever input is higher from either the first trigger 50 or the second 52 trigger is used to control the speed module 114.

Each of the first trigger 50 and second trigger 52 variable speed triggers output a voltage signal based on the amount that the respective trigger is pressed. The speed module 114 uses the highest voltage of the first trigger 50 and second trigger 52, which signal is passed through the trigger comparison circuit 120 as described above, as the voltage used to control the variable speed control.

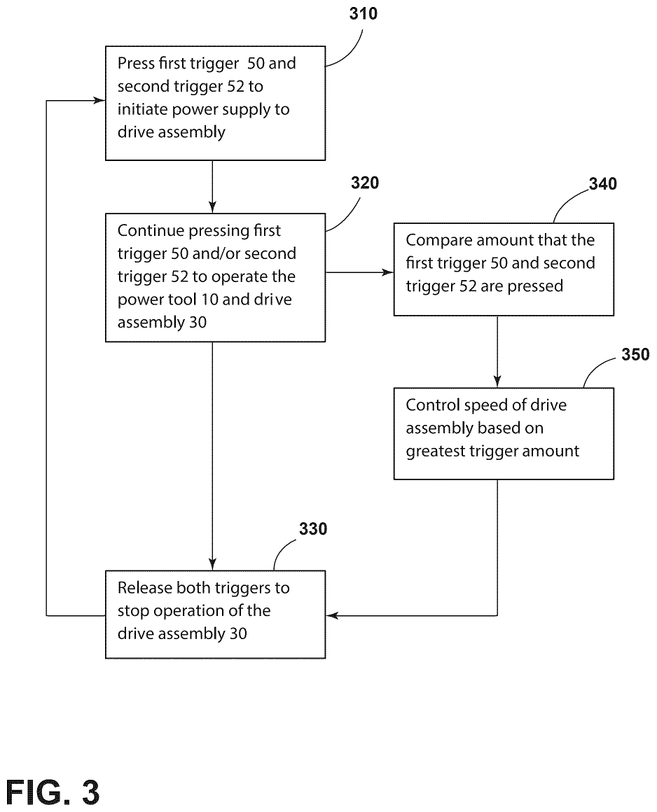

FIG. 3 illustrates a flow chart of a method 300 for operating the power tool 10. To begin operation of the power tool 10 at step 310, a user presses the first trigger 50 and the second trigger 52. As described above, the power module 112 may require pressing the first trigger 50 and the second trigger 52 simultaneously. As a result of pressing the first trigger 50 and the second trigger 52, the control circuit 110 causes initiation of the drive assembly. At step 320, the drive assembly 30 is operated with the first trigger 50 and/or the second trigger 52 pressed. At step 330, when both triggers 50, 52 are released, operation of the drive assembly 30 is ceased or stopped, i.e., the power supply is cut off.

As further shown in FIG. 3, step 340 of the method includes comparing the amount that the first trigger 50 and the second trigger 52 are pressed. For instance, the trigger comparison circuit 120 may determine which trigger is pressed a greater amount. Then, at step 350, the controller 100 controls the speed of the drive assembly 30 based on the greatest trigger amount. For instance, the amount the trigger is pressed results in a trigger voltage input signal. The controller 100 may control the speed of the drive assembly 30 based on the greatest voltage.

Further aspects of the disclosure are provided by one or more of the following embodiments:

An outdoor power tool comprising: a tool assembly; a drive assembly; a handle assembly coupled to the tool assembly and/or the drive assembly; a control system comprising a control circuit; a first trigger and a second trigger, the first trigger and the second trigger each being electrically connected to the control circuit; wherein the control system is configured to initiate supply of electric power to the drive assembly when an input is received at the control circuit from both the first trigger and the second trigger.

The outdoor power tool of any one or more of the embodiments, wherein after initiating supply of electric power to the drive assembly, the control system is configured to maintain supply of electric power to the drive assembly when an input is maintained from at least one of the first trigger and/or the second trigger.

The outdoor power tool of any one or more of the embodiments, wherein the control system is configured to cease supply of electric power to the drive assembly when both the first trigger and the second trigger are released.

The outdoor power tool of any one or more of the embodiments, wherein the first trigger and the second trigger are variable speed triggers.

The outdoor power tool of any one or more of the embodiments, wherein the control system is configured to compare the input of the first trigger and the input of the second trigger, and to control a velocity of the drive assembly based on a greater of the input of the first trigger and the input of the second trigger.

The outdoor power tool of any one or more of the embodiments, wherein the first trigger generates a first trigger input when the first trigger is pressed and the second trigger generates a second trigger input when the second trigger is pressed.

The outdoor power tool of any one or more of the embodiments, wherein the control circuit comprises an initiation circuit, wherein the initiation circuit is configured to output an initiation signal when the initiation circuit receives the first trigger input and the second trigger input.

The outdoor power tool of any one or more of the embodiments, wherein the control circuit comprises an operation circuit, wherein the operation circuit is configured to receive the initiation signal from the initiation circuit and to output an operation signal as long as the first trigger and/or the second trigger is pressed.

The outdoor power tool of any one or more of the embodiments, wherein the operation circuit ceases output of the operation signal when both the first trigger and the second trigger are released.

The outdoor power tool of any one or more of the embodiments, wherein the user interface is incorporated into the handle assembly.

The outdoor power tool of any one or more of the embodiments, wherein the handle assembly comprises a first handle and a second handle, wherein the first handle and the second handle extend on opposite lateral sides with respect to a direction of movement of the drive assembly.

The outdoor power tool of any one or more of the embodiments, wherein the first trigger is disposed on the first handle and the second trigger is disposed on the second handle.

A method of operating an outdoor power tool, the outdoor power tool comprising a drive assembly, a control system, and a first trigger and a second trigger, the method comprising steps of: pressing the first trigger and the second trigger simultaneously; the control system causing initiation of the drive assembly as a result of the step of pressing the first trigger and the second trigger simultaneously; operating the drive assembly with the first trigger and/or the second trigger pressed; and ceasing operation of the drive assembly when neither the first trigger nor the second trigger is pressed.

The method of any one or more of the embodiments, wherein a speed of operation of the drive assembly is controlled by the amount that the first trigger and/or the second trigger is pressed.

The method of any one or more of the embodiments, further comprising a step of the control system comparing an amount the first trigger is pressed and an amount the second trigger is pressed, determining which trigger is pressed a greater amount, and controlling the speed of operation of the drive assembly based on the trigger that is pressed a greater amount.

An apparatus as shown and described in one or more embodiments herein.

A system configured to operate in accordance with any one or more of the embodiments disclosed herein.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An outdoor power tool comprising:
a tool assembly;
a drive assembly; a handle assembly coupled to the tool assembly and/or the drive assembly;
a control system comprising a control circuit;
a first trigger and a second trigger, the first trigger and the second trigger each being electrically connected to the control circuit;
wherein the control system is configured to initiate supply of electric power to the drive assembly when an input is received at the control circuit from both the first trigger and the second trigger.

2. The outdoor power tool of claim 1, wherein after initiating supply of electric power to the drive assembly, the control system is configured to maintain supply of electric power to the drive assembly when an input is maintained from at least one of the first trigger and/or the second trigger.

3. The outdoor power tool of claim 1, wherein the control system is configured to cease supply of electric power to the drive assembly when both the first trigger and the second trigger are released.

4. The outdoor power tool of claim 1, wherein the first trigger and the second trigger are variable speed triggers.

5. The outdoor power tool of claim 1, wherein the control system is configured to compare the input of the first trigger and the input of the second trigger, and to control a velocity of the drive assembly based on a greater of the input of the first trigger and the input of the second trigger.

6. The outdoor power tool of claim 1, wherein the first trigger generates a first trigger input when the first trigger is pressed and the second trigger generates a second trigger input when the second trigger is pressed.

7. The outdoor power tool of claim 6, wherein the control circuit comprises an initiation circuit, wherein the initiation circuit is configured to output an initiation signal when the initiation circuit receives the first trigger input and the second trigger input.

8. The outdoor power tool of claim 7, wherein the control circuit comprises an operation circuit, wherein the operation circuit is configured to receive the initiation signal from the initiation circuit and to output an operation signal as long as the first trigger and/or the second trigger is pressed.

9. The outdoor power tool of claim 8, wherein the operation circuit ceases output of the operation signal when both the first trigger and the second trigger are released.

10. The outdoor power tool of claim 1, wherein the user interface is incorporated into the handle assembly.

11. The outdoor power tool of claim 1, wherein the handle assembly comprises a first handle and a second handle, wherein the first handle and the second handle extend on opposite lateral sides with respect to a direction of movement of the drive assembly.

12. The outdoor power tool of claim 11, wherein the first trigger is disposed on the first handle and the second trigger is disposed on the second handle.

13. A method of operating an outdoor power tool, the outdoor power tool comprising a drive assembly, a control system, and a first trigger and a second trigger, the method comprising steps of:
pressing the first trigger and the second trigger simultaneously;
the control system causing initiation of the drive assembly as a result of the step of pressing the first trigger and the second trigger simultaneously;
operating the drive assembly with the first trigger and/or the second trigger pressed; and
ceasing operation of the drive assembly when neither the first trigger nor the second trigger is pressed.

14. The method of claim 13, wherein a speed of operation of the drive assembly is controlled by the amount that the first trigger and/or the second trigger is pressed.

15. The method of claim 14, further comprising a step of the control system comparing an amount the first trigger is pressed and an amount the second trigger is pressed, determining which trigger is pressed a greater amount, and controlling the speed of operation of the drive assembly based on the trigger that is pressed a greater amount.
